(19) United States
(12) Patent Application Publication
(10) Pub. No.: US 2007/0060108 A1
(43) Pub. Date: Mar. 15, 2007

(54) System and method of obtaining directions to scheduled events

(75) Inventors: Allen Michael East, Cary, NC (US); Paul W. Carpenter, Raleigh, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB

(21) Appl. No.: 11/226,544

(22) Filed: Sep. 14, 2005

(51) Int. Cl. H04Q 7/38

(52) U.S. Cl. 455/414.1

(57) ABSTRACT

A wireless communications device includes application logic and scheduling logic. The scheduling logic allows a user to create and maintain a schedule of events the user is interested in, and notifies the user of a scheduled event based on event data stored in memory of the wireless communications device. The application logic interfaces with the scheduling logic to determine when the scheduled event will occur, and generates a request for directions to a location of the scheduled event. The request may include event data associated with the scheduled event. A server receives the request and determines the directions based on the event data. The server sends the directions to the wireless communications device, which displays the directions to the user.

### BACKGROUND

The present invention relates generally to wireless communications devices, and particularly to wireless communications devices having scheduling functionality.

Wireless communication devices typically provide a wide array of functionality in addition to facilitating communications with remote parties. For example, some wireless communication devices are equipped with software that allows users to maintain a calendar or schedule of upcoming events. Conventionally, the user adds an event such as a meeting to his or her calendar or schedule and a time at which the event will begin. The user may also define other data associated with the event, such as a location of the event, and a time at which the software should notify the user of the event. At times, the user may be aware of how to get to the location of the scheduled event. Other times, however, the location of the event may be unknown to the user.

To obtain directions to unknown locations, users may go on-line and use any of a number of available mapping programs. MAPQUEST, YAHOO, and GOOGLE, for example, all provide web-based applications that allow users to obtain directions to a particular location. However, the user is often required to manually enter starting and ending locations. This information may already exist in the contents of the calendar or scheduling application. Therefore, a user could benefit from obtaining directions at a wireless communications device without having to manually enter this information.

### SUMMARY

In one embodiment, the present invention provides a wireless communications device having application logic and scheduling logic. The scheduling logic allows a user to maintain a calendar or schedule of events. The user may define and store event-related data in memory of the wireless communications device such a time the event begins and an indicator associated with a location of the event. The application logic interfaces with the scheduling logic to access the event-related data, and uses the event-related data to obtain directions to the event location. In one embodiment, the application logic may obtain the location of the event and directions to the event from a server via a wireless communications network. The user may view a graphical representation of the location of the event and/or directions to the event on a display.

By way of example, the application logic may determine when a scheduled event for a user will occur. The application logic may prompt the user to determine whether the user already knows where the event location is, and whether the user needs directions to the event. Depending on the user input (e.g., ask/do not ask for directions), the application logic may obtain an indicator associated with the scheduled event from the scheduler logic. The application logic may than generate a request message that includes the indicator, and send the message to the server. In one embodiment, the indicator comprises an address of where the event will occur. In other embodiments, however, the indicator comprises an identifier associated with the user or a telephone number of a telephone at the event location. The server determines the location of the event based on the indicator in the request message, and returns the location information to the wireless communications device. Upon receipt, the application logic may graphically display the directions for the user as a map on the display.

In some embodiments of the present invention, the request message may also include a current location of the wireless communications device. In these cases, the generated request message could include both the indicator associated with the event and the current location of the wireless communications device. Upon receipt of the request, the server might determine the location of the event based on the indicator and suggest a route from the user's current location to the event location. The server sends this information to the wireless communications device 10, which graphically displays the received information as a map for the user. The map may include indications of the current location of the wireless communications device, the location of the event, and the suggested route determined by the server.

### BRIEF DESCRIPTION OF THE DRAWINGS

FIG. 1 illustrates a wireless communications device configured according to one embodiment of the present invention.

FIG. 2 illustrates a communications network of a type that a wireless communications device configured according to one embodiment of the present invention may operate.

FIG. 3 illustrates a conceptual view of the logic according to one embodiment of the present invention.

FIG. 4 illustrates a method by which a wireless communications device may obtain directions to a location of a scheduled event according to one embodiment of the present invention.

FIG. 5 illustrates a map that may be displayed to the user according to one embodiment of the present invention.

FIG. 6 illustrates a method by which a wireless communications device may obtain directions to a location of a scheduled event according to an alternate embodiment of the present invention.

FIG. 7 illustrates a map that may be displayed to the user according to an alternate embodiment of the present invention.

FIG. 8 illustrates a method by which a wireless communications device may obtain directions to a location of a scheduled event according to another embodiment of the present invention.

### DETAILED DESCRIPTION

The present invention comprises a wireless communications device and corresponding method that provides a user with directions to a scheduled event. As used herein, the term “wireless communication device” may include a cellular radiotelephone, a Personal Communication System (PCS) terminal, a Personal Digital Assistant (PDA) that can include a radiotelephone, Internet/intranet access, web browser, organizer, calendar, and/or a global positioning system (GPS) receiver, a conventional laptop and/or palmtop receiver, or other appliance or mobile terminal.

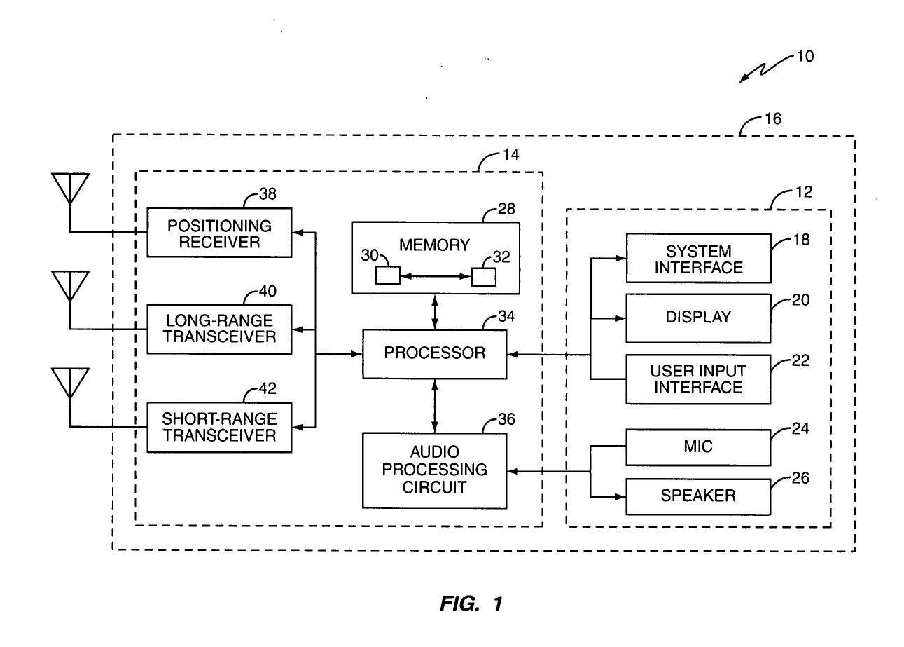

FIG. 1 illustrates a wireless communication device 10 configured according to one embodiment of the present invention. Wireless communication device 10 includes a user interface 12 and a communications interface 14 in a housing 16. User interface 12 includes a system interface 18, a display 20, a user input interface 22, a microphone 24, and a speaker 26.

User interface 12 generally permits the user to interact with and control wireless communication device 10. System interface port 18 may comprise a “male” or “female” connector that allows the user to connect wireless communications device 10 with any number of desired peripheral devices. Such devices include, but are not limited to, a desktop computing device (not shown) having a calendar application and associated event data stored thereon. In one embodiment of the present invention, the user may connect the wireless communications device 10 to the desktop computing device via system interface 18 to download/upload event data from/to the desktop computing device.

Display 20 allows a user to view information such as menus and menu items, dialed digits, images, video, call status information, and output from user applications. According to the present invention, display 20 may additionally allow the user to view a graphical representation of the location of a scheduled event, and/or directions from the user's current location to the location of the scheduled event. The display 20 may display the location and/or directions graphically (e.g., a map), textually, or both. The graphical representations may indicate the location of the event, the current location of the wireless communications device 10, and a suggested route between the current location and the event location.

User input interface 22 may include input devices such as a keypad, touchpad, joystick control dials, control buttons, and other input devices, or a combination thereof. The user input interface 22 allows the user to dial numbers, enter commands, scroll through menus and menu items presented to the user on display 20, and make selections. In addition, user input interface allows the user to control how display 20 displays graphical representations of the location and directions to a scheduled event. As described below, a user may employ user input interface 22 to zoom in/out and pan the map vertically and horizontally as needed or desired. Microphone 24 receives and converts audible signals, such as the user's detected speech and other audible sound, into electrical audio signals that may be processed by audio processing circuit 36. Speaker 26 receives analog audio signals from audio processing circuit 36, and converts them into audible sound that the user can hear.

Communications circuitry 14 includes, inter alia, the components necessary to allow a user to communicate with one or more remote parties via a communications link. Communications circuitry 14 comprises memory 28, a processor 34, an audio processing circuit 36, an optional positioning receiver 38, such as a Global Positioning (GPS) receiver, a long-range transceiver 40, and a short-range transceiver 42. Each of the positioning receiver 38, the long-range transceiver 40, and the short-range transceiver 42 may be coupled to one or more antennas as known in the art.

Memory 28 represents the entire hierarchy of memory in wireless communications device 10, and may include both random access memory (RAM) and read-only memory (ROM). Computer program instructions and data required for operation are stored in non-volatile memory, such as EPROM, EEPROM, and/or flash memory, and may be implemented as discrete devices, stacked devices, or integrated with processor 34. Memory 28 may store one or more software programs and associated data that may be executed by processor 34. For example, application logic 30 and scheduling logic 32 are examples of software programs that may be stored in memory 28 according to one embodiment of the present invention. As described in more detail below, scheduling logic 32 typically maintains data associated with events for the user. Application logic 30 may interface with scheduling logic 32 to determine this information, and request directions to the location of the event using this information.

Processor 34 controls the operation of wireless communications device 10 according to programs and/or data stored in memory 28. The control functions may be implemented in a single microprocessor, or in multiple microprocessors. Suitable processors may include, for example, both general purpose and special purpose microprocessors. Processor 34 may interface with audio processing circuit 36, which provides basic analog output signals to speaker 26 and receives analog audio inputs from microphone 24.

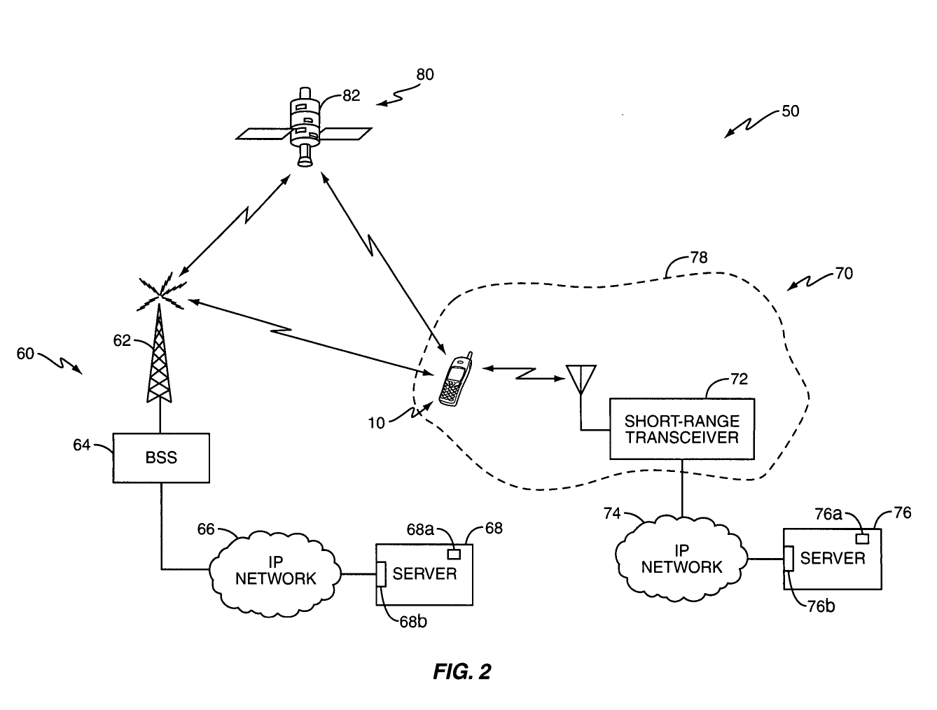

The wireless communications device 10 may also include a positioning receiver 38 for receiving navigational signals from a satellite system 80 (FIG. 2) or terrestrial communications network 60 (FIG. 2). As is known in the art, wireless communications device 10 may determine its position using these signals. One example of such a satellite navigation system is the U.S. Global Positioning System (GPS). The wireless communications device 10 may determine its position from GPS signals independently, or alternatively, it may receive assistance data, such as satellite ephemeris data or approximate location, from a communication network. As those skilled in the art will appreciate, a wide variety of other systems and methods for determining the location of wireless communications device 10 have been developed. For example, the relative signal strengths, signal propagation delay, phase shift, or the like of signals transmitted by the wireless communications device 10 may be used to locate the position of the wireless communications device 10. Any of these systems and methods may be advantageously applied to the present invention.

Long-range transceiver 40 allows a user to communicate wireless signals to and from a base station in a wireless communications network. Long-range transceiver 40 may be a fully functional cellular radio transceiver that operates according to any known standard, including the standards known generally as the Global System for Mobile Communications (GSM), TIA/EIA-136, cdmaOne, cdma2000, UMTS, and Wideband CDMA. In addition, long-range transceiver 40 may include baseband-processing circuits to process the transmitted and received signals. Alternatively, however, baseband-processing circuits may be incorporated in processor 34.

Short-range transceiver 42 allows a user to communicate wireless signals to and from a corresponding short-range transceiver. In one embodiment, short-range transceiver 42 is a BLUETOOTH transceiver or, in another embodiment, RF transceiver operating according to the IEEE 802.11 (b) or 802.11 (g) standards. As is well known in the art, BLUETOOTH is a universal radio interface that permits the creation of ad hoc networks, and is particularly well-suited for communications over short distances. It should be understood, however, that short-range transceiver 42 may utilize any technology known in the art operable to transmit and receive signals over short distances, for example, infra-red, and hardwired cables.

FIG. 2 illustrates a communications network 50 in which a wireless communications device 10 configured according to one embodiment of the present invention may operate. Network 50 may comprise one or more of a wireless communications network 60, an ad-hoc wireless network 70, and a satellite system 80 having one or more satellites 82. As previously stated, satellite system 80 and/or wireless communications network 60 may provide the wireless communications device 10 with navigational signals that allow wireless communications device 10 to determine its geographical position. The positioning data may be used in the present invention as described below.

Wireless communications network 60 may be a communications network operating according to any of the known standards for Global System for Mobile Communications (GSM), TIA/EIA-136, cdmaOne, cdma2000, UMTS, and Wideband CDMA. As known in the art, network 60 typically comprises an antenna 62 and a Base Station Subsystem (BSS) 64 to facilitate communications between wireless communications device 10 and one or more remote parties. The BSS 64 may connect to a server 68 having a controller 68a and communications interface 68b via a private or public IP network 66.

According to one embodiment of the present invention, wireless communications device 10 may generate and send a message to server 68 via network 60 requesting directions to the location of a scheduled event. The request message may include a current position of the wireless communication device 10, and/or an indicator associated with the scheduled event location. The indicator may be, for example, an address of the event location or a phone number of a telephone at the event location. Based on the indicator, the server 68 determines the location and sends the location of the event to the wireless communications device 10 via network 60. Where the request message also includes the current location of the wireless communications device 10, server 68 may determine and send directions from the user's current location to the event location.

In an alternate embodiment, wireless communications device 10 may obtain the location or directions to the event location via an ad-hoc network 70. This embodiment may be useful, for example, on college university campuses or in large corporate settings. In this embodiment, short-range transceiver 72 may detect when wireless communications device 10 is proximate a predefined zone 78. Alternatively, short-range transceiver 42 may detect short-range transceiver 72 when it nears zone 78. However detection occurs, short-range transceiver 72 and short-range transceiver 42 establish a short-range communications link, as known in the art. As in the previous embodiment, wireless communications device 10 may generate a request message including an indicator associated with the event's location. Short-range transceiver 72 may forward the request to a server 76, which has a controller 76a and a communications interface 76b, via a public or private IP network 74. Server 76 may then determine and send the location of the event based on the indicator to wireless communications device 10 via the short-range transceiver 72.

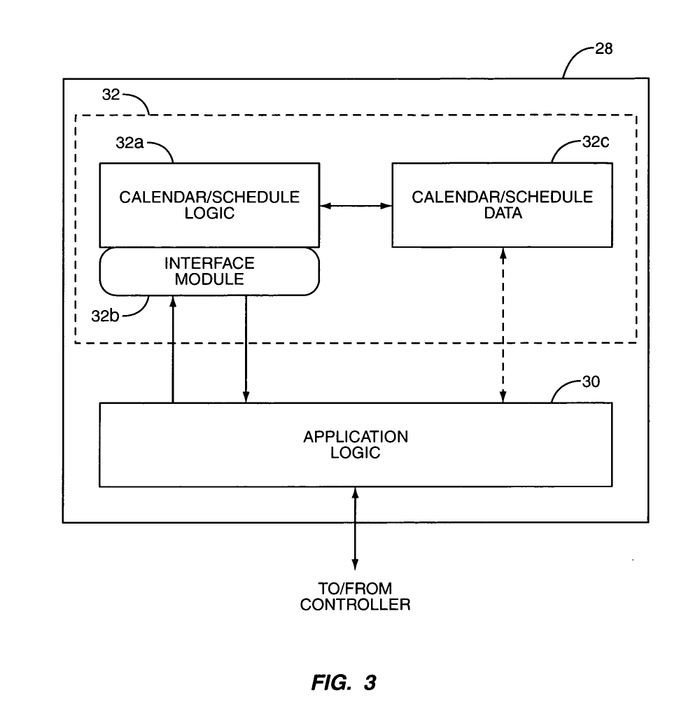

FIG. 3 illustrates a conceptual model of the logic of the present invention. Generally, scheduling logic 32 allows the user of wireless communications device 10 to maintain and update a schedule of events the user is interested in attending. This includes, but is not limited to, entering and updating the data associated with the events, such as an event time and an indication of where the event will occur. Other event-related data may also be defined, stored, and utilized by the present invention as needed or desired. Scheduler logic 32 also usually notifies the user when an upcoming event will occur. The notification may be an audible and/or visual indication (e.g., a pop-up window) showing the user the date, time, and place of the event.

As seen in FIG. 3, scheduling logic 32 may comprise calendar/scheduler logic 32a, an interface module 32b, and data 32c associated with scheduled events. As stated above, the user may enter the data 32c when the user creates the event. The user might create the event using the scheduling logic 32 on wireless communications device 10. Alternatively, the user might create the event and enter the event-related data on a computing device such as a desktop computer. The user may periodically synchronize the event-related data stored in memory 28 on the wireless communications device 10 with the event-related data stored in the computing device to ensure the data is substantially the same on both devices.

The application logic 30 interfaces with the scheduler logic 32 via the interface module 32b. The interface module 32b may be, for example, a plug-in that allows application logic 30 to access event data and/or communicate messages with the scheduler logic 32. In one embodiment, for example, scheduler logic 32 may notify application logic 30 of the occurrence of a pending event associated with the user of wireless communications device 10. Responsive to these notifications, application logic 30 could access the event data to obtain an indicator associated with the location of the event, and use the indicator in a request message to obtain the location and/or directions to the event.

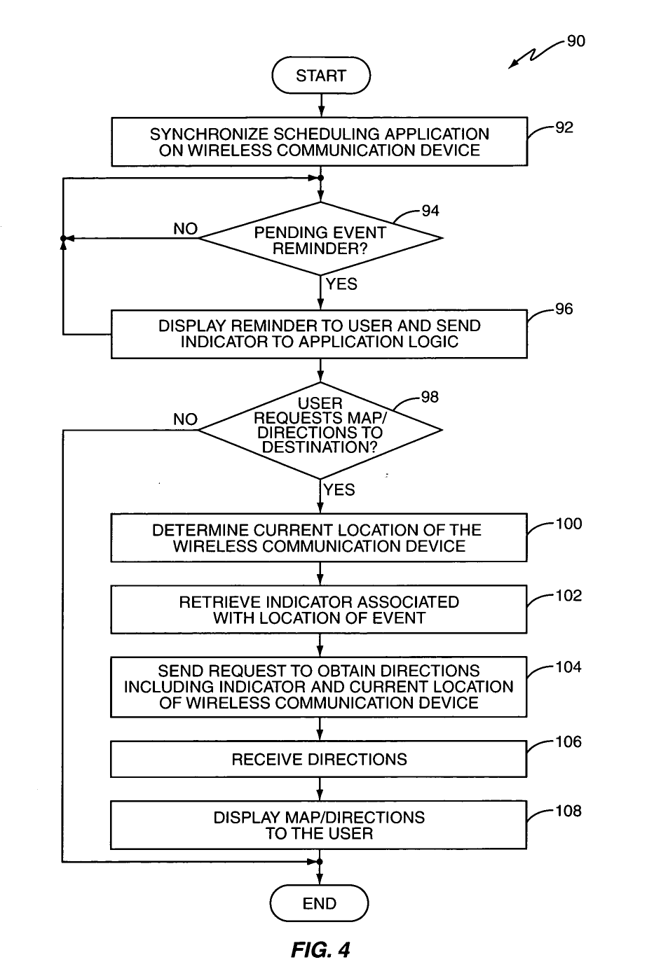

FIG. 4 illustrates a method 90 wherein the wireless communications device 10 obtains directions to the location of a scheduled event according to a first embodiment of the present invention. In this embodiment, the user may first synchronize the event data stored in memory 28 with the data from a corresponding scheduler application resident on the user's personal computer, as known in the art (box 92). The scheduler application might be, for example, MICROSOFT OUTLOOK® or some other available application. The scheduling logic 32 on the wireless communications device 10 may periodically check to determine if an event is pending (box 94), and notify the user of the event before it is to occur. Additionally, the scheduling logic 32 may also send an indication to the application logic 30 regarding the pending event (box 96). The scheduler logic may than continue to determine the next pending scheduled event.

Upon receipt of the indication, application logic 30 may prompt the user to determine whether the user requires directions to the location of the event (box 98). For example, the application logic 30 might display a pop-up dialog to the user. If the user does not require directions to the event location, the application logic 30 may remove the dialog from the display 20 and wait for the next indication from the scheduler logic 32. However, if the user requires directions, the application logic 30 determines the current location of wireless communications device 10 using any method known in the art (box 100). Application logic also determines an indicator associated with the location of the event (box 102). In this example, the user, upon creating the event, may have entered an address of the location where the event will occur. Application logic 30 may access the data for the event directly or via scheduling logic 32 to retrieve the address from memory 28. Alternatively, the scheduler logic 32 may pass this information to the application logic 30 with the notification indication.

Application logic 30 than generates a message requesting the directions, and includes the current location of the wireless communications device 10 and the address of the event location in the request message (box 104). The message is sent to a server 68 via the wireless communications network 60. The server 68 determines the location of the event and the directions to the event based on the received information, and returns the information to the user. Wireless communications device 10 receives the directions (box 106) and sends them to display 20 for viewing by the user (box 108).

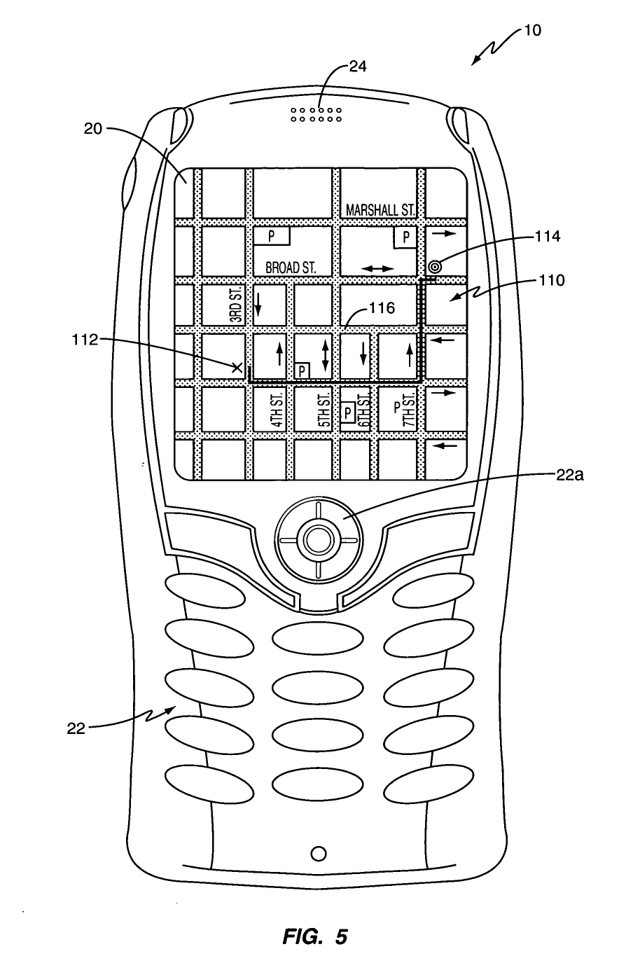

The wireless communications device may display the directions graphically as a map, or as text depending upon the capabilities of the wireless communications device 10 and/or the server 68. In one embodiment, seen in FIG. 5, the wireless communications device 10 displays the directions graphically as a map 110. The map 110 may indicate the current location 112 of the user, and the location 114 of the event. The map 110 may also indicate a suggested route 116 the user could travel to arrive at the event location 114. Server 68, for example, may determine the location 114 and the suggested route 116 using any method known in the art, and provide the information to wireless communications device 10. The user may employ a navigation disk 22a or other control on user input interface 22 to control the map display. For example, the user may employ user input interface 22 to zoom in and out, or pan the map vertically and horizontally on display 20.

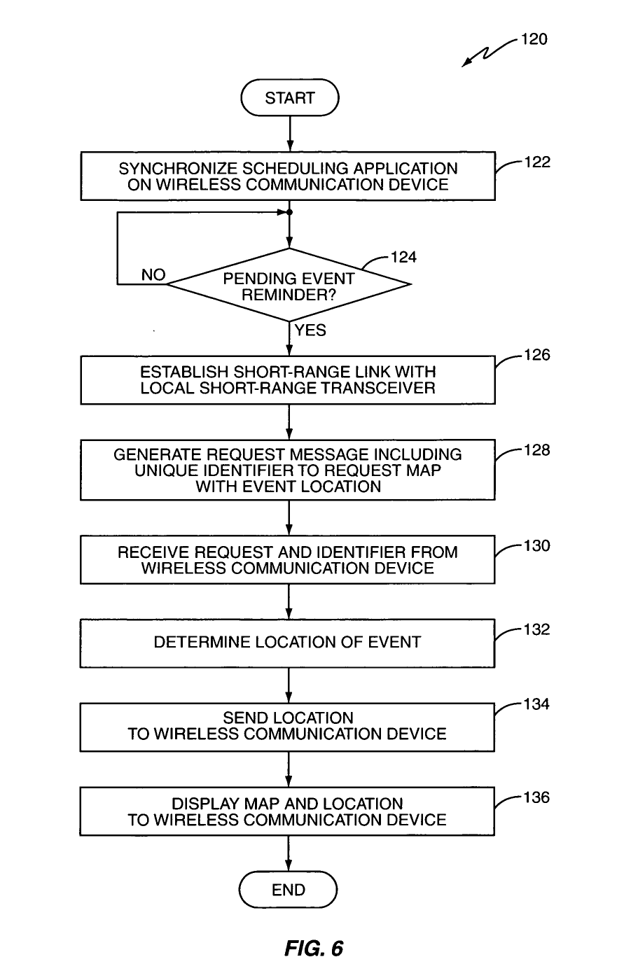

FIG. 6 illustrates an alternate method 120 wherein wireless communications device 10 includes a short-range transceiver 42 that communicates with a corresponding short-range transceiver 72 to obtain the location of an event. This embodiment may be useful, for example, in university or corporate campuses. As in the previous embodiment, the user may synchronize the event data stored in memory 28 with the data from a corresponding scheduler application resident on the user's personal computer (box 122). Additionally, the scheduler logic 32 determines that the next pending event will occur and notifies the user (box 124). If not already accomplished, short-range transceivers 42, 72 establish a short-range communications link as known in the art (box 126).

Application logic 32 may than generate the request for the location (box 128). Generating the request message may be done automatically without user interaction, as seen in FIG. 6, or depending on the user's answer to a prompt. The request, in this embodiment, includes a unique identifier known to the user and to the server 76. For example, the identifier may be a building and/or room number, or may be a student or employee ID. The server 76 receives the request from wireless communications device 10 (box 130) and retrieves the information from memory (box 132). Where the unique identifier is a student ID, for example, the server 76 may cross-reference the student ID with a copy of the student's schedule stored at the server 76. Based on the schedule, server 76 could determine a building and/or room number of a class or meeting the user is supposed to attend, and return the information to the user (box 134). In one embodiment, the information may be embodied as a map of the campus indicating the event location. The wireless communications device 10 could than display the map to the user (box 136).

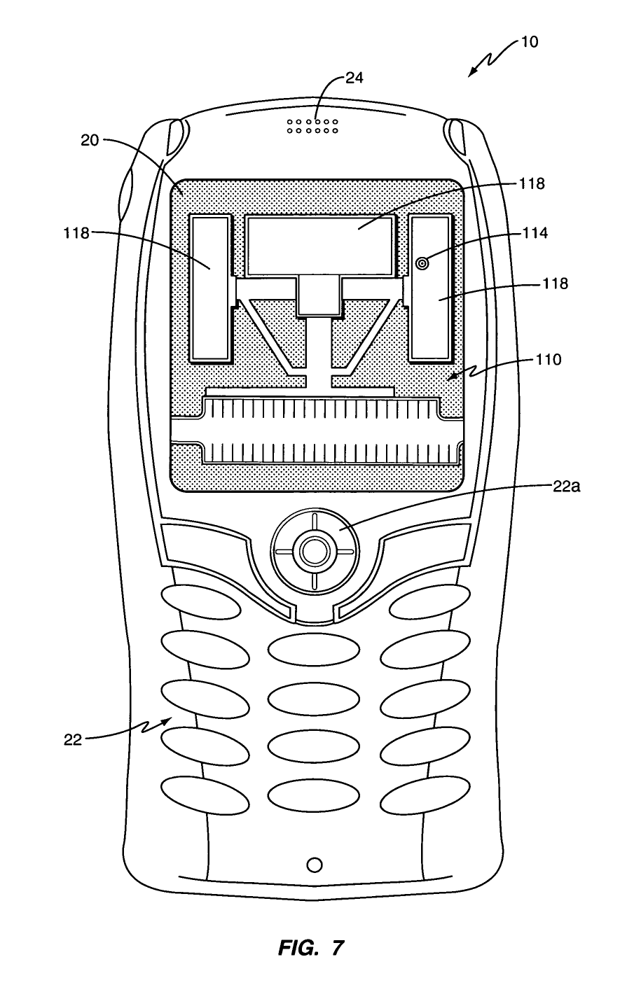

FIG. 7 illustrates an example of the map 110 displayed to the user according to the embodiment of FIG. 6. The map 110 may indicate one or more buildings 118 of a campus and the location 114 of the event. Additionally, while not shown specifically on FIG. 7, the map may indicate the current position of the user and a suggested route to the location 114 of the event. As above, the user may employ user interface 22 to control the display 20.

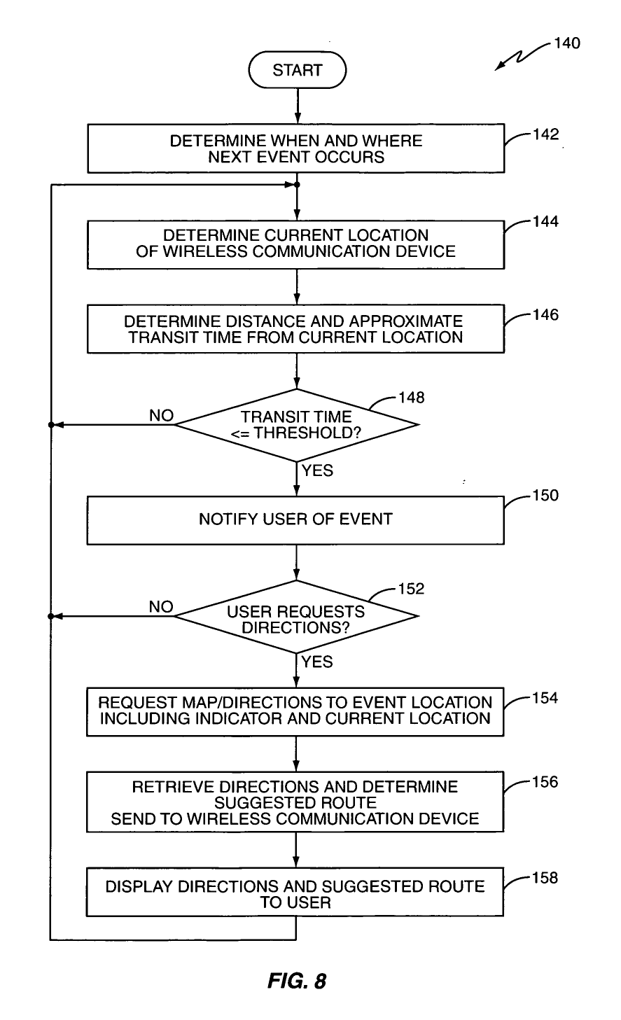

FIG. 8 illustrates a method 140 according to another embodiment wherein application logic 30 estimates a transit time from a user's current location to an event location. Application logic 30 may generate the request for directions based on the estimated transit time. Generating the request for directions to the location based on an estimated transit time might assist the user in making the scheduled event on time.

In this embodiment, application logic 30 may periodically access the event data to determine when and where a scheduled event will occur (box 142). Application logic 30 will also periodically determine the current location of the wireless communications device 10 (box 144). For example, positioning receiver 38 may be a GPS receiver that periodically determines the geographical coordinates of the wireless communications device 10. Other methods of determining the current location are also available and well known. The application logic 30 may use the geographical coordinates to calculate an estimated transit time between the user's current location and the event location (box 146).

Application logic 30 may compare the estimated transit time to a threshold defined by the user (box 148). For example, the user may set a threshold value to ensure that the user is prompted for directions 30 minutes prior to the start of an event. If the estimated transit time is greater than 30 minutes, the application logic will return to periodically updating the current location of the wireless communications device 10 and the estimated transit time. However, if the estimated transit time is less than or equal to 30 minutes, the application logic 40 may notify the user of the event (box 150), and prompt the user to request directions (box 152). If the user does not want the directions, application logic 30 simply performs the same functionality for the next event. Otherwise, application logic 30 generates the request message and sends the message to the server 68 or 72 (box 154). Server 68 or 72 retrieves the directions for transmission to the user (box 156). Upon receipt, application logic 30 may display the directions on display 20 for viewing by the user (box 158).

The location indicator of the previous embodiments has been described in terms of an address or a student ID. However, this is for illustrative purposes only. There may be times when the user does not know the address of an event location beforehand, and therefore, cannot provision the address when creating the event. In these cases, the present invention may employ other event-related data, such as the telephone number of a telephone located at the event location. Particularly, application logic 30 may include the telephone number in the request message. Whichever server 68, 72 receives the request may than use the telephone number to determine the event location. For example, the server 68, 72 may use the telephone number as an index into a private or public database that associates telephone numbers with specific addresses. Once server 68, 72 determines the address, it may return the information to the requesting wireless communications device 10 for display to the user.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of indicating a scheduled event to a user of a wireless communications device, the method comprising:
storing event data associated with a scheduled event, the event data including an event time and an event indicator associated with a location of the scheduled event;
requesting directions to the location associated with the scheduled event based on the event indicator;
receiving the directions responsive to the request;
notifying a user of a wireless communications device of the scheduled event; and
displaying the directions to the location of the event to the user.

2. The method of claim 1 wherein requesting directions to the location associated with the scheduled event based on the event indicator comprises sending the event indicator to a server via a wireless communications network.

3. The method of claim 2 wherein the event indicator comprises a destination location of the scheduled event.

4. The method of claim 2 wherein the event indicator comprises a telephone number associated with the scheduled event.

5. The method of claim 2 wherein the event indicator comprises a unique identifier associated with the user of the wireless communications device.

6. The method of claim 5 wherein the unique identifier comprises an employee number of the user.

7. The method of claim 2 wherein the event indicator comprises a room number associated with the scheduled event.

8. The method of claim 1 wherein notifying the user of the scheduled event is based on a transit time between a current location of the wireless communications device and the location associated with the scheduled event.

9. The method of claim 8 wherein requesting directions to the location is based on the transit time.

10. The method of claim 1 wherein displaying the directions to the user comprises graphically indicating a destination location associated with the scheduled event.

11. The method of claim 10 further comprising graphically indicating a current location of the wireless communications device.

12. The method of claim 11 further comprising graphically indicating a suggested route from the current location to the destination location.

13. A wireless communications device comprising:
scheduling logic configured to notify a user of a scheduled event based on event data associated with the scheduled event, the event data including an event time and an event indicator associated with a location of the scheduled event;
application logic configured to generate a request message for directions to the location of the scheduled event based on the event indicator; and
a display configured to display the directions to the location of the scheduled event.

14. The device of claim 13 further comprising a transceiver to transmit the request message to a server in a wireless communications network and to receive the directions from the server.

15. The device of claim 13 wherein the application logic is further configured to determine a transit time between a current location of the wireless communications device and the location associated with the scheduled event, and generate the request message for directions based on the transit time.

16. The device of claim 15 wherein the scheduling logic is configured to notify the user of the scheduled event based on the transit time.

17. The device of claim 13 wherein the application logic is further configured to prompt the user to request the directions, and generate the request based on user input to the prompt.

18. The device of claim 13 wherein the application logic is configured to include the event indicator in the request message.

19. The device of claim 18 wherein the event indicator comprises a destination location of the scheduled event.

20. The device of claim 18 wherein the event indicator comprises a telephone number associated with the scheduled event.

21. The device of claim 18 wherein the event indicator comprises a unique identifier associated with the user of the wireless communications device.

22. The device of claim 21 wherein the unique identifier comprises an employee number of the user.

23. The method of claim 18 wherein the event indicator comprises a room number associated with the scheduled event.

24. The device of claim 13 wherein the displayed directions indicate a destination location of the scheduled event.

25. The device of claim 24 wherein the displayed directions indicate a current location of the wireless communications device, and a suggested route from the current location to the destination location.

26. A server to provide directions to a location of a scheduled event comprising:
a communications interface operative to:
communicatively connect the server to a wireless communications device; and
receive a request for directions to a location of a scheduled event, the request including event data associated with the location of the scheduled event; and
a controller configured to:
determine the directions to the location of the scheduled event based on the event data received with the request; and
send the directions to the user of the wireless communications device via the transceiver.

27. The server of claim 26 wherein the controller is configured to determine a current location of the wireless communications device.

28. The server of claim 27 wherein the event data received by the controller includes the current location of the wireless communications device.

29. The server of claim 27 wherein the controller is configured to send the wireless communications device a suggested route to the location of the scheduled event based on the current location of the wireless communications device and the location of the scheduled event.

30. The server of claim 26 wherein the event data comprises a destination location of the scheduled event.

31. The server of claim 26 wherein the event data comprises an identifier associated with the user of the wireless communications device.

32. The server of claim 26 wherein the event data comprises a telephone number associated with the scheduled event.

33. The server of claim 26 wherein the controller is configured to send the directions to the wireless communications device as text.

34. The server of claim 26 wherein the controller is configured to send the directions to the wireless communications device as information that represents a map of the location of the scheduled event.
